(19) United States
(12) Patent Application Publication
(10) Pub. No.: US 2014/0365385 A1
(43) Pub. Date: Dec. 11, 2014

(54) IES CAPABLE OF SEMI-AUTOMATICALLY GENERATING/ INVOKING ALL LEGAL ARGUMENT CHAINS (LACS) IN THE SPL TEST OF A CLAIMED INVENTION (CI), AS ENABLED BY ITS INVENTIVE CONCEPTS (INCS)

(71) Applicant: Sigram SCHINDLER, Berlin (DE)

(72) Inventor: Sigram SCHINDLER, Berlin (DE)

(21) Appl. No.: 14/294,825

(22) Filed: Jun. 3, 2014

Related U.S. Application Data
(63) Continuation-in-part of application No. 14/165,225, filed on Jan. 27, 2014.
Application No. 14/165,225 is a continuation-in-part of application No. 13/923,630, filed on Jun. 21, 2013.
Application No. 13/923,630 is a continuation-in-part of application No. 13/777,416, filed on Feb. 26, 2013.
Application No. 13/777,416 is a continuation-in-part of application No. 13/608,543, filed on Sep. 10, 2012.
Application No. 13/608,543 is a continuation of application No. 12/756,254, filed on Apr. 8, 2010, now abandoned.
Application No. 13/608,543 is a continuation-in-part of application No. 13/229,362, filed on Sep. 9, 2011, now abandoned.
Application No. 13/229,362 is a continuation-in-part of application No. 13/093,682, filed on Apr. 25, 2011, now abandoned.
(60) Provisional application No. 61/913,677, filed on Dec. 9, 2013.
(60) Provisional application No. 61/923,000, filed on Jan. 2, 2014.
(60) Provisional application No. 61/925,367, filed on Jan. 9, 2014.
(60) Provisional application No. 61/820,932, filed on May 8, 2013.
(60) Provisional application No. 61/814,492, filed on Apr. 22, 2013.
(60) Provisional application No. 61/803,631, filed on Mar. 20, 2013.
(60) Provisional application No. 61/704,848, filed on Sep. 24, 2012.
(60) Provisional application No. 61/708,253, filed on Oct. 1, 2012.
(60) Provisional application No. 61/710,219, filed on Oct. 5, 2012.
(60) Provisional application No. 61/717,706, filed on Oct. 24, 2012.
(60) Provisional application No. 61/736,715, filed on Dec. 13, 2012.
(60) Provisional application No. 61/750,084, filed on Jan. 8, 2013.
(60) Provisional application No. 61/533,499, filed on Sep. 12, 2011.
(60) Provisional application No. 61/537,202, filed on Sep. 21, 2011.
(60) Provisional application No. 61/539,699, filed on Sep. 27, 2011.
(60) Provisional application No. 61/542,988, filed on Oct. 4, 2011.
(60) Provisional application No. 61/546,187, filed on Oct. 12, 2011.
(60) Provisional application No. 61/569,534, filed on Dec. 12, 2011.
(60) Provisional application No. 61/590,474, filed on Jan. 25, 2012.
(60) Provisional application No. 61/592,072, filed on Jan. 30, 2012.
(60) Provisional application No. 61/599,607, filed on Feb. 16, 2012.
(60) Provisional application No. 61/610,656, filed on Mar. 14, 2012.
(60) Provisional application No. 61/614,827, filed on Mar. 23, 2012.
(60) Provisional application No. 61/622,653, filed on Apr. 11, 2012.
(60) Provisional application No. 61/624,554, filed on Apr. 16, 2012.
(60) Provisional application No. 61/639,270, filed on Apr. 27, 2012.
(60) Provisional application No. 61/656,286, filed on Jun. 6, 2012.
(60) Provisional application No. 61/671,977, filed on Jul. 16, 2012.
(60) Provisional application No. 61/673,525, filed on Jul. 19, 2012.
(60) Provisional application No. 61/680,420, filed on Aug. 7, 2012.
(60) Provisional application No. 61/683,377, filed on Aug. 15, 2012.
(60) Provisional application No. 61/684,899, filed on Aug. 20, 2012.
(60) Provisional application No. 61/697,593, filed on Sep. 6, 2012.
(60) Provisional application No. 61/319,088, filed on Mar. 30, 2010.
(60) Provisional application No. 61/313,860, filed on Mar. 15, 2010.
(60) Provisional application No. 61/304,549, filed on Feb. 15, 2010.
(60) Provisional application No. 61/296,089, filed on Jan. 19, 2010.
(60) Provisional application No. 61/263,679, filed on Nov. 23, 2009.
(60) Provisional application No. 61/261,585, filed on Nov. 16, 2009.
(60) Provisional application No. 61/259,930, filed on Nov. 10, 2009.
(60) Provisional application No. 61/255,372, filed on Oct. 27, 2009.
(60) Provisional application No. 61/252,894, filed on Oct. 19, 2009.
(60) Provisional application No. 61/240,401, filed on Sep. 8, 2009.
(60) Provisional application No. 61/236,366, filed on Aug. 24, 2009.
(60) Provisional application No. 61/234,376, filed on Aug. 17, 2009.
(60) Provisional application No. 61/227,565, filed on Jul. 22, 2009.
(60) Provisional application No. 61/223,127, filed on Jul. 6, 2009.
(60) Provisional application No. 61/219,209, filed on Jun. 22, 2009.
(60) Provisional application No. 61/184,938, filed on Jun. 8, 2009.
(60) Provisional application No. 61/183,279, filed on Jun. 2, 2009.
(60) Provisional application No. 61/181,998, filed on May 28, 2009.
(60) Provisional application No. 61/170,217, filed on Apr. 17, 2009.
(60) Provisional application No. 61/169,159, filed on Apr. 14, 2009.
(60) Provisional application No. 61/168,036, filed on Apr. 9, 2009.
(60) Provisional application No. 61/497,140, filed on Jun. 15, 2011.
(60) Provisional application No. 61/504,435, filed on Jul. 5, 2011.
(60) Provisional application No. 61/515,493, filed on Aug. 5, 2011.
(60) Provisional application No. 61/522,865, filed on Aug. 12, 2011.
(60) Provisional application No. 61/526,831, filed on Aug. 24, 2011.
(60) Provisional application No. 61/528,431, filed on Aug. 29, 2011.
(60) Provisional application No. 61/531,358, filed on Sep. 6, 2011.
(60) Provisional application No. 61/352,528, filed on Jun. 8, 2010.
(60) Provisional application No. 61/374,312, filed on Aug. 17, 2010.
(60) Provisional application No. 61/380,377, filed on Sep. 7, 2010.
(60) Provisional application No. 61/384,770, filed on Sep. 21, 2010.
(60) Provisional application No. 61/387,217, filed on Sep. 28, 2010.
(60) Provisional application No. 61/389,829, filed on Oct. 5, 2010.
(60) Provisional application No. 61/394,822, filed on Oct. 20, 2010.
(60) Provisional application No. 61/407,076, filed on Oct. 27, 2010.
(60) Provisional application No. 61/408,291, filed on Oct. 29, 2010.
(60) Provisional application No. 61/408,790, filed on Nov. 1, 2010.
(60) Provisional application No. 61/410,066, filed on Nov. 4, 2010.
(60) Provisional application No. 61/410,971, filed on Nov. 8, 2010.
(60) Provisional application No. 61/412,822, filed on Nov. 12, 2010.
(60) Provisional application No. 61/413,517, filed on Nov. 15, 2010.
(60) Provisional application No. 61/414,483, filed on Nov. 17, 2010.
(60) Provisional application No. 61/415,021, filed on Nov. 18, 2010.
(60) Provisional application No. 61/415,964, filed on Nov. 22, 2010.
(60) Provisional application No. 61/416,478, filed on Nov. 23, 2010.
(60) Provisional application No. 61/417,330, filed on Nov. 26, 2010.
(60) Provisional application No. 61/417,477, filed on Nov. 29, 2010.
(60) Provisional application No. 61/418,179, filed on Nov. 30, 2010.
(60) Provisional application No. 61/420,058, filed on Dec. 6, 2010.
(60) Provisional application No. 61/426,825, filed on Dec. 23, 2010.
(60) Provisional application No. 61/427,244, filed on Dec. 27, 2010.
(60) Provisional application No. 61/428,941, filed on Dec. 31, 2010.
(60) Provisional application No. 61/431,129, filed on Jan. 10, 2011.
(60) Provisional application No. 61/435,551, filed on Jan. 24, 2011.
(60) Provisional application No. 61/440,053, filed on Feb. 7, 2011.
(60) Provisional application No. 61/442,896, filed on Feb. 15, 2011.
(60) Provisional application No. 61/447,401, filed on Feb. 28, 2011.
(60) Provisional application No. 61/472,915, filed on Apr. 7, 2011.
(60) Provisional application No. 61/476,162, filed on Apr. 15, 2011.
(60) Provisional application No. 61/477,870, filed on Apr. 21, 2011.

(51) Int. Cl. G06Q 50/18; G06F 3/0484

(52) U.S. Cl. CPC G06Q 50/184; G06F 3/0484
USPC 705/310

(57) ABSTRACT

A computer-implemented method, by its execution
realizing an “Innovation Expert System, IES”—comprising at least a processor, a memory for storing the method's executable code for the processor, at least one I/O device for IES's interactions with an IES user, an “Items/Events Memory, I/EM” for storing all items and events the method refers to, and a “User Interface Entity, UIE” ::={<KR-UIE, HI-UIE, IC-UIE>.Y|YεY^{UIE}}—
   in its config-mode generating and customizing a set of “legal argument chain, LAC”, {LAC},
      for a given “PTR Data Structure, PTR^{FFOLLIN}-DS” determined by the FSTP^{FFOLLIN}-Test,
      and an “Arguable Subtest, AST”εFSTP^{FFOLLIN}-Test—omitting “^{FFOLLIN}” in the future—with {LAC}::={LAC^{AST}.Z|LAC^{AST}.Z proves TT.0 passes AST∀ZεZ^{AST}}, whereby ∀ZεZ^{AST}⊂Y^{UIE} holds
         KR-UIE.Z comprises the AST,
         HI-UIE.Z is input by a user, and
         IC-UIE.Z is determined by a user;
   in its realtime-mode presenting an invoked generated and/or customized LAC^{AST}.Z, ZεZ^{AST};
when executed by the IES, the latter repeatedly consecutively invokes and completely executes, for any IES user separately, the action A) when the IES is in a config-mode resp. the action B) when the IES is in a realtime-mode, which means that for an IES user the IES then
A) i. automatically identifies a ZεZ^{AST} for which a LAC^{AST} exists already or an ASTεFSTP-Test(PTR) to be transformed into a LAC,
   ii. automatically prompts a user to input into said identified KR-UIE.Z said AST, into its HI-UIE.Z what the representation shall be of this AST on what I/O device, and into its IC-UIE.Z what interactive control a user shall have during said representation of said AST,
   iii. automatically may accept information from at least one IES user to be communicated to at least one other IES user's I/O device(s),
   iv. on request of an IES user toggles this IES user's mode of the IES to the realtime-mode.
B) i. automatically identifies a LACε{LAC^{AST}},
   ii. automatically identifies an AST then automatically identifies a LACε{LAC^{AST}},
   iii. on having determined said LAC, presents it as defined in A)ii. or predefined,
   iv. automatically may accept information from at least one IES user to be communicated to at least one other IES user's I/O device(s);
   v. on request of an IES user toggles this IES user's mode of the IES to the config-mode.

### GLOSSARY

The below quoted and underlined phrases used by the specification have the following meanings:
a) “on direct or indirect request by an IES user” says that this IES user may by itself invoke a function (=request its execution directly) or else it may be prompted by the IES to invoke a function (=request its execution indirectly).
b) “several different LACs about any AST of a CI/TT.0” shall indicate that the existence of several LACs need not only be due to an IES user having defined several different multimedia presentations for a LAC, but may also be caused by the AST itself comprising different ways of reasoning, e.g. having different disclosures for an inC the AST deals with and/or having for a disclosure more than one legal justification.
c) An answer provided by the IES to a query put by an IES user (as to at least one aspect of at least one inC of the CI at issue) is called “complete and concise” if it addresses and comprises all relevant legal and technical information and presents this information such that it shows the CI meets all respective requirements stated by SPL—unlike information provided by the classical claim construction, as missing both these objectives.
d) “question raised by an IES user intentionally or not” says that the user may raise this question quite purposefully, i.e. targeted, or incidentally, i.e. by chance e.g. in presenting an argument.
e) The different “logics” of an AST denote the various kinds this AST may present some issue, e.g. justify why an inC is disclosed by the specification or why the inCs in a set are independent.
f) “All ASTs for a given CI and its FFOLLIN” says that any part of this CI's FSTP^{FFOLLIN}-Test is covered by an AST, i.e. the CI's complete FSTP^{FFOLLIN}-Test understood as a logical conjunction of basic logic statements is decomposed into sets of BASTs (see γ) above).
g) Two LACs are “nonredundant”, if the ASTs they represent share no BAST.

“LAC”: Any instantiation of it—when invoked (and created by the IES for its partial existence during the execution of the UIE.Y defining it) on direct or indirect request by an IES user—responds to one of the finitely many questions (anticipated in its config-mode) by an answer potentially in multimedia presentation (determined in its config-mode) instantly, correctly, completely, concisely, and to some degree user controllable by an IES user as to this answer's presentation and/or its logics. The occurrence of this question, raised by an IES user intentionally or not, is the reason of this instantiation's invocation. The issue addressed by this question is one of the finitely many aspects of testing a given CI for its satisfying the requirement(s) stated by the given respective FFOLLIN instantiation. The set of all LACs defined, for a given FFOLLIN and its CI in config-mode, establishes the total usefulness of this CI provided by the so configured IES in this FFOLLIN.

“AST”: Any instantiation of it enables accessing a specific part of the FSTP-DS—potentially finer than that of an FSTP-test.o and/or stretching over parts of several FSTP-test.o—whereby all ASTs, for a given CI and its FFOLLIN, in total cover this CI's FSTP^{FFOLLIN}-DS. Thus, the usefulness of an AST instantiation consists in its providing access, in the CI's test for satisfying its given FFOLLIN, to that part of the FSTP^{FFOLLIN}-Test represented by this AST instantiation.

“IC-UIE”: Any instantiation of it enables structuring and controlling the presentation of any part of any LAC.

“HI-UIE”: Any instantiation of it enables determining the multimedia aspects and didactic presentation of any LAC.

“KR-UIE”: Any instantiation of it enables supporting the presentation of any LAC by an appropriate choice of the logics of the AST.

### I. INTRODUCTION

This SPL¹⁾ oriented patent application is a continuation in part of U.S. Ser. No. 14/165,225. ¹ While today differences still exist between the “Substantive Patent Laws, SPLs” of the US and other regions/nations, e.g. the EU with the SPL of its EPC, these should disappear soon, as internationally harmonizing so understood SPLs is politically not too controversial and economically highly beneficial for all parties as then being “Highest Courts” proof—in the US totally, in the EU and many Industrial nations vastly. Similar processes occurred in the past, e.g. with the national accounting procedures of public companies, today harmonized by the worldwide IFRS (International Financial Reporting Standard). Here, the PatentHighwayProgram of several large PTOs may play a decisive role.

The US Supreme Court's Mayo decision [1,18,19] requires describing a claimed invention (“CI”) by its “inventive concepts, inCs” if it deals with emerging technology subject matter and hence is “model based”—and thus stimulated Advanced IT [2] research on decision making in testing such CIs under SPL, also holding if describing the CI needs no model [11,18,19,25,36,45,71,78].

Models are e.g.: The “ISO/OSI” model of telecommunications, “molecular bonding forces” models of nano-technology, “RNA/DNA” models of genetics, “Natural Language” models of Advanced IT—some standardized, all implicitly used by SPL precedents without being aware of this. The philosophical synonym of the term model is “paradigm”, the scientific one “reference system”, e.g. “coordinate system”. Using a model often enables describing a CI precisely on top of it, though it itself is not understood precisely—as practiced with mathematics' “axioms/theorems/proofs”, with physics' “laws of nature”, and here with SPL's “claimed inventions”. The here claimed invention is applicable to all model based CIs.

[10,18,19,25,46,47] proved: A CI satisfies SPL if it passes the “FSTP-Test”. Thus, the FSTP-Test may (semi-)automatically deliver all different “Legal Argument Chains, LACs” showing a CI satisfies SPL. This greatly facilitates every patent practitioner's decision making as to testing a CI under SPL, in particular if it is model based. SPL reasoning is always of finite first order logic (“FFOL”).

A system based on a CI's alias TT.0's PTR^{SPL}-DS [6,7] which stores all SPL-relevant functional and nonfunctional properties of this CI—is called an “Innovation Expert System, IES”, if it has a “User Interface Entity, UIE” enabling its user(s) to access of this CI all (legally nonredundant) LACs showing its satisfying SPL. An IES leverages on its PTR-DS embodying, by all results of its CI's FSTP-Test, all “Arguable Subtests, ASTs”—these being the blueprints of all LACs of this CI. Automatic LACs generation according to this invention is not limited to CIs' tests under SPL, as shown in Section II.

The UIE of an IES is made-up from UIE.Ys, Y=1, 2, . . . , any one comprising a knowledge representation “KR-UIE.Y”, a human interaction “HI-UIE.Y”, and an interaction control “IC-UIE.Y” entity, in config-/realtime-mode used separately resp. synchronously. An IES or a user of it invokes between them an “interaction”. In config-mode an interaction serves for generating or modifying of a UIE.Y by a user at least 1 of its just quoted 3 components. In realtime mode an interaction serves for invoking, controlled by its IC-UIE.Y, the presentation of a HI-UIE.Y. In both modes this interaction uses its KR-UIE.Y, which in turn uses the knowledge stored by PTR-DS [11,25]. A UIE.Y may be subdivided into (potentially nested) “UIE.Y Steps”; invoking a UIE.Y causes at least executing one of them partially.

A LAC.Z, Z=1, 2, . . . , is presented by executing at least 1 partial UIE.Y in realtime-mode. An AST.X, X=1, 2, . . . , is accessed by at least 1 KR-UIE.Y, each translated into at least 1 LAC.Z. An AST.X may be used in at least 1 “logics presentation”, tied to at least 1 HI-UIE.Y by its own IC-UIE.Y, as customized by an IES user in config-mode—between which a user may toggle by invoking these IC-UIE.Ys. I.e.: In config-mode of the IES, any AST is (semi-)automatically transformable into its 1 or more LAC.Zs, being AST's in various logics presentations translated into multimedia presentations by UIE.Ys—as needed by a judge, examiner, lawyer, inventor, . . . . In realtime-mode a user may toggle between these UIE.Ys of an AST.X for highlighting its aspects by the LAC.Zs into which AST.X is translated.

FIG. 1 shows an AST.1 translated into 3 LAC.a/b/c by their UIE.1a/1b/1c of 1/2/3 sequential UIE.1a^{[1]}/1b^{[1,2]}/1c^{[1,2,3]} steps semi-automatically generated/customized in config-mode by defining by an IES user their respective 6<HI-UIE.Ys, KR-UIE.Ys, IC-UIE.Ys>. FIG. 2 shows that AST.1 may have 2 logics presentations, leading to 3 more powerful LAC.d/e/f by their UIE.1d/1e/1f, again based on 6 steps (lines) in total. More information about the FIGS. 1/2 is provided by the end of Section II.

### II. ON GENERATING ALL LACS FOR A CI'S TEST UNDER ANY FFOLLIN¹⁾²⁾

² Due to the novelty of this part of the specification, many details—also evident—ones were briefly explained in Section II. Such trivialities ought to be superfluous in a patent application, the specification of which comprises this part. If a future patent application were supported by its PTR-DS—or even by an IES as disclosed here—all such explanations, also trivial ones, would be presented to a user on its request in realtime, potentially in utmost controllable multimedia presentation.

This patent application leverages on scientific insights achieved in the FSTP project, the Reference List of which, quoting their publications, is provided by the ANNEX. They showed, how all ASTs—all being non-isomorphic—of a CI/TT.0 tested under SPL, may semi-automatically be transformed, using an IES in config-mode, into their peer LACs, which in the realtime-mode of the IES then may be automatically invoked, as outlined in Section I. The role of the FFOLLIN is explained after α)-ζ) below.

For conveying the working of the IES in config-mode, the below bullet points specify technical features of an IES enabling a user of it to configure alias calibrate alias customize it according to the needs of its user(s) in its realtime-mode. Thereby one or several users may use the IES simultaneously in config- and/or realtime-mode, thus directly or indirectly communicating with each other. The understanding of the working of the IES in realtime-mode immediately follows from its config-mode understanding. They add such features sometimes redundantly, as explained already above and/or by these publications.

Section III, defining the meanings of this CI's in Cs and of the claims as wholes—if not evident already from the inCs' definitions then leverages on these explanations in Section II, as they provide the interpretation basis of these meanings. These bullet points thus also disclose the scope of this CI.
By [25], a CI satisfies SPL if it passes the FSTP-Test (see FIG. 3). And: A CI passing FSTP-test.m, 2≦m≦10 (on top of a subset S resp. S′ of TT.0's finite set of all its BED-inCs) passes all FSTP test.n, 1≦n<m, on top of this set. The inverse of this implication evidently needs not to hold.
The complete FSTP-Test is a program evaluating, for a CI under SPL test, the whole FFOL expression modeling the logics (see below) of and between the 11 concerns embodied by the 35 USC SPL over the mirror predicates of BED-inCs of this CI, the conjunctions of these BED-inCs' mirror predicates modeling the properties of the elements of the CI. Their peers in prior art TTs may or may not exist—as decided by an FSTP-Test user (and confirmed by the posc)—forming the ANC matrix.
Any AST is a lexically and syntactically correct “sentence” alias FFOL term from within this whole FFOL expression. Hence, for any CI, there are only finitely many ASTs, and for any AST its semantic is evident (except the semantics of the above properties and the relations between them that the user/posc has input into the PTR-DS when generating it—here assumed to be correct).
PTR dependent, only finitely many (usually few hundred) ASTs exists. All these ASTs are executable on top of these finitely many and PTR-dependent BED-in-C subsets. All these ASTs, resp. their BASTAs (see below) are the blueprints for all LACs. Other (legally nonredundant) LACs don't exist though different presentations to IES users of any AST as different LACs may.
Any UIE.Y for any AST.X (to be translated into a LAC.Z) may be generated in config-mode by an IES user by its invoking the “UIE-stub” provided by any IES implementation and delivering to it this UIE.Y, depending on the parameters of this invocation being a fresh UIE.Y or an existing and defined UIE.Y for checking or changing the result of preceding input, or the interworking between presenting several UIE.Y invocations of LAC.Z, or its interworking with other LAC.Z′ presentations. Thereby any UIE.Y may be composed by the user of one or several sequential “UIE steps, UIESes”, whereby any UIES again may be composed by the user of one or several sequential such steps (“nested UIE.Ys”). Any UIE.Y and UIES.Y must be specified by the user—except automatic ones, depending on the particular IES implementation and/or configuration—as to the functionalities of their 3 resp. KR-/HI-/IC-UIE.Ys or KR-/HI-/IC-UIES.Ys.
The just mentioned 3 components of any UIEs may vastly be generated automatically by the IES or interactively generated by a user guided by the IES—not elaborated on in this patent application—and would basically be the same or similar, i.e. are principally stereotypical.
Thereby the objective of the claimed invention presented here, is not limited to providing for a given CI only all LAC.Zs for justifying solely its classical claim construction—such LAC.Zs would only show that the CI has a chance to satisfy SPL—but to provide all LAC.Zs showing CI satisfies SPL.
After automatically or semi-automatically/interactively having decomposed in config-mode, as deemed reasonable by an IES user, all the PTR-DS into all ASTs, any one potentially in a multitude of ASTs' logics, into peer LACs' multimedia representations and user interaction capabilities (as shown by FIGS. 1/2 and the below steps α)-ζ)), in realtime-mode these ASTs or LACs may be invoked automatically (e.g. by an acoustic word spotter of the IES), and/or (semi-)automatically by an IES user (see the below steps α)-ζ)). Thereby its execution may comprise specific items for communicating with a user, e.g. about any kind of management issues. Pertinent ordinary skill knows, e.g. from IVR systems and their audio pattern spotting and matching functionalities, how in principle to (semi-)automatically identify in realtime LACs to be instantly invoked, as the dialog just taking place generates an appropriate pattern. Here such LAC identification and invocation processes in realtime-mode may be substantially supported by the IES calibration providing resp. hints to these processes, e.g. leveraging on graphical and/or acoustic patterns embodied by a related multimedia thesaurus construction based on “AST patterns”.
The complete FSTP-Test of a CI for its satisfying 35 USC SPL comprises the 10 FSTP-test.o, 1≦o≦10 of FIG. 3. It is executed for the “set V claim interpretations, Sol” of the CI, selected in (b)/(c) therein, i.e. all TT.0s of this CI—a CI may enable several interpretations, if disclosed by its patent's (application's) specification [71,78]. The term/notion “technical teaching 0, TT.0” [6,7,11] then stands for one them [71,78]. I.e.: The TT.0s are the elements of the CI's “set of interpretations, Sol”.
Note that there is a variety of execution sequences of the FSTP-Test for any one of these TT.0s: While the initialization sequence of the 10 FSTP test.o's must be that of their natural number indexes, they may be executed exhaustively or overlapping—i.e., for the latter case holds: ∀FSTP-test.n check of this CI only those of its inCs already confirmed by the FSTP-test.m ∀m<n.
Advanced IT knows that the input and commands provided by an IES user to the IES just as the latter's output to an IES user must have, for being understandable by both, some before given—here a priori defined by the IES—alphabet(vocabulary) and syntax and semantics and pragmatics or these must be determined during the execution of the claimed invention's FSTP-Test by the IES under rules given a priori by the IES and under the control by an IES user.
The term/notion “legal argument chain, LAC” stands for what is commonly understood by any posc with knowledge of the SPL. Its broad meaning is not limited in any other way. The index “Z” identifies a particular LAC.Z, more precisely: an instantiation Z of the “type LAC” (in terms of programming languages). The same applies for the types/instantiations “AST”/“AST.X”, “UIE”/“UIE.Y”, . . . .
The above UIE-stub provided by an IES on top of a PTR-DS—representing a CI's TT.0 to be tested for satisfying SPL—is available to an IES user all the time (unless locked by a user). As said above already: By means of the UIE-stub an IES user may define a broad range of UIE instantiations for configuring the UIE between an IES user and the IES for customizing the CI's SPL test for the IES user: Such as to facilitate for it using the functionality provided by the IES for this test.
Whether a UIE.Y is to be generated/integrated/modified or executed is determined by the mode the IES is in at UIE.Y invocation time—whereby this mode may be set by an IES user (e.g. the one performing this invocation or another one) or by the IES and/or at whatsoever time of the existence of this UIE.Y and of the function execution being invoked. Thereby conflicts may occur and must be resolved by the implementation of the IES, either automatically or interactively with an IES user.
Any invocation may refer to only a step within a UIE instantiation.
The content of a human interaction, i.e. its semantics, is currently transparent to the IES unless it is automatically derived by the IES from the AST at issue, potentially occurring for very simple ASTs.

The usefulness of the here disclosed CI—i.e. of the IES resp. of the method controlling it—is to be seen in the HI-UIEs' capability of (semi-)automatic instant information presentations by one or several different LACs about any AST of a CI's TT.0 under e.g. SPL test to an IES user, in response to the latter's invocation of some detail of the PTR-DS or its FSTP-Test representing this TT.0 resp. this detail.

The claimed invention has been invented, in particular, for thus enabling the IES to present automatically or interactively a LAC in response to a question being asked, as if this response were provided by a human being of total knowledge about the TT.0 being SPL tested.

To this end, this response must be represented by the IES—by having the person speaking and showing what it graphically uses for support of its presentation, both in reality or on a screen, anyway all media used in synchrony, what would be the normal cases in realtime mode use of the IES—as it were presented without the support by the IES. For achieving this, the IES enables a user first to acoustically and/or graphically input fragments of the arguments it later intends to present in its personalized fashion, then to combine these fragments into what it considers to be a complete legal argument chain, and finally to invoke the automatic reproduction of this argument. Responding this way to a listener/viewer of this LAC—to a question it or somebody else had input to the claimed invention before as a query—then would appear to the listener/viewer as a personal and potentially multimedia announcement/information of a smart IMR system (IMR=interactive multimedia response). This “user personalization” of the behavior of the claimed invention's IMR subsystem would comprise that an IES user and the IES may cooperate in jointly presenting a complex LAC by alternatively speaking or reacting on interposed questions by answering them immediately—whereby such prompt reactions may be configured, also by IC-UIE.Ys, to be interventions and/or accompanying illustrations, always under an IES user control. Variants of such interactions are disclosed by Sections III and IV.

For achieving this result, the IES would execute many steps of such a whole process automatically or interactively, as outlined in α)-ζ) below. E.g., when directly or indirectly (i.e. on IES request) invoked by an IES user, the IES may basically:
α) recognize by/for which “high level user interaction”—due to the FFOL nature of the problem only finitely many such user interactions are required by an IES—this invocation occurred, then
β) derive, for this interaction, which technical items and/or legal items from the FSTP-DS it needs,
γ) determine, by which “basic AST arguments, BASTAs” (see below) they are covered—due to the FFOL nature of the problem, i.e. of the FSTP-Test, there is only a finite number of BASTs for any TT.0, the respective TT.0 independent BASTAs would be provided by the IES, and the TT.0 dependent BASTAs would be input by an IES user into the IES under the latter's guidance being controlled by the PTR-DS prior to using the IES as outlined by α)-ζ)—then
δ) compile from these BASTAs some “sequence of BASTA, SoBASTA”—due to the FFOL nature of the problem any sequence is correct, yet second thoughts being useful—a single complete sequence of “low level answers” to these question, and have a KR-UIE instantiation represent this SoBASTA,
   ε) translate this low level SoBASTA into one or several specific—but logically equivalent to each other and to the SoBASTA—sequences of future (if working in config-mode) or actual (if working in realtime-mode) multimedia outputs on what I/O devices, and have the same number of HI-UIE instantiations represent these future/actual outputs, whereby each such instantiation provides, potentially supported by the KR-UIE alias SoBASTA, a specific basis for one or several sequences of high-level user interactions invoked above but executed under the control of ζ), and finally)
   ζ) determine, for any HI-UIE instantiation of ε), when in the future (if working in config-mode) or actually (if working in realtime-mode) on what event how to output on what I/O devices which part of this or another one of these HI-UIE instantiations of ε), and have for this HI-UIE instantiation its specific IC-UIE instantiation represent these future/actual interaction controls—thus linking, to commands of IES users, not only parts of HI-UIE instantiations of ε) but also what any latter part needs for its execution from a KR-UIE.

Some comments on the steps α)-ζ) and in particular on this CI's philosophy may be helpful:
Any step requires some interactive input from or control by an IES user or executes fully automatic.
These steps differ when invoked in different modes, e.g. i) in explorative/calibrating/config-mode, ii) in reply-testing-mode, iii) in “one-way”-reply-mode, iv) in “two-way”-alias “interactive”-reply-mode, v) in some “consolidation”-reply mode, . . . .
The BASTAs (=basic AST arguments) in step γ) represent a complete (usually neither not unique nor non-redundant) finite set of basic building blocks into which the whole FSTP-Test may be decomposed. In any BASTA the term “basic” has the meaning that it deals with only a single factual alias “technical” and/or legal question as to one of the 10 FSTP-test.o (which enables dealing e.g. with the finitely many such details or evaluations or relations of some kinds of inCs or the FSTP-test.o at issue), and the term “argument” indicates that the BASTAs are translated into the basic building blocks also of the LACs.
While an embodiment of the CI of this patent application working with the steps α)-ζ) uses the functionality specified for the CI in a pretty sophisticated manner, for the person of posc its implementation would nevertheless be straightforward realizable. This holds the more for the CI's simpler embodiments, always achievable by appropriately limiting the I/O flexibility of such embodiments.
In addition to the steps α)-ζ), an embodiment of the claimed invention may provide “prototypes” of all user interactions and modes it provides, as well as macros for the stereotypically recurring parts when invoking them, such as repeating some passage in other words or particularly slowly, or skipping momentarily boring details, or prompting a user to continue, or asking for confirmation the understanding of the just said, or . . . .
LACs may also be presented by their default configurations coming with user interactions specific for models of application areas (see Section I). These prototype interactions are fine for inputting/defining/configuring specific UIE instantiations by a user for its personalization of the IES and/or its LACs for adapting them to the specificities of the actual PTR-DS under test—but normally these prototypes' functioning is not yet what an IES user ideally would like to use.
This patent application nowhere uses peculiarities of an SPL¹⁾ or its FSTP-Test. I.e., SPLs are too narrow for specifying it. The next paragraphs shall clarify this and thus determine the scope of the CI of this patent application.

Speaking in terms of programming languages: SPL, “Substantive Copyright Law, SCL”, . . . , may be seen as a range of “directive” type declarations, the defining commonality of which is their being a “finite FOL legal norm, FFOLLN”. Hence, any such directive type declaration may be called FFOLLN and is defined by a finite set of conjunctively to be met requirements by any instantiation of this directive type, i.e. by any subject matter satisfying it.

Here, any instantiation of a FFOLLN would occur by means of a subject matter being a CI of FFOL, thus by means of a finite set of BED^{SCL}-inCs generative for this CI [71]. Hence, this instantiation being a subject matter defined by this CI of this FFOLLN—is called “finite FOL legal invention norm, FFOLLIN”.

Based on this understanding, one sees that the scope of this patent application's CI indeed comprises any IES^{FFOLLIN}—which is confirmed by a careful analysis of the claims claiming this CI. Thus, from the above programming language considerations and definitions follows (in generalization of the considerations in e.g.[10,18,19,25], mathematically reconsidered by [73], and putting it in terms independent of programming language and legal jargon): The scope of the CI of this patent application comprises any equally powerful “test of a creation necessary and sufficient for its meeting a given requirement, TC.NaS.MR”.

Being “equally powerful” means: This CI enables building for any FFOLLIN an IES^{FFOLLIN}, which by customization/configuration becomes that knowledgeable that, if asked a question about this TT.0^{FFOLLIN}'s satisfying a requirement its FFOLLIN instantiation states, it may instantly respond by one or several correct and complete LACs, their presentations being controllable by an IES user (as detailed above).

This generalization evidently impacts also on the FSTP^{SPL}-Test determining the PTR^{SPL}-DS, implying that an FSTP^{TCNaSMR}-Test determines a PTR^{TCNaSMR}-DS. Writing just “FSTO^{FFOLLN}-Test” and “PTR^{FFOLLN}-DS” is less specific in notation, but implies the same. This generalization even may be expanded to the FFOLLN's dependency on non-finite parameters, e.g. time. I.e., the CI of this patent application has, as clearly indicated already in Section I, a much broader application area—i.e. all FFOLxNs areas, “x” standing not only for “law” but also for any private “directive”—than the one repeatedly explicitly addressed above for exemplary purposes, namely 35 USC SPL.
An IES^{FFOLLIN} defined by some FFOLLIN creation alias “technical teaching.0, TT.0^{FFOLLIN}”—defined to be a CI the properties of the elements of which are precisely describable by conjunctions of the mirror-predicates of this TT.0's BED^{FFOLLIN}-inCs—is all-knowing (in the above described sense) as to TT.0^{FFOLLIN}'s satisfying this FFOLLN, and is comprised by claim 16. E.g.: An IES^{SPL} defined by a CI^{SPL}'s BED^{SPL}-inCs and the FSTP^{SPL}-Test is all knowing about CI^{SPL}'satisfying this SPL.
This enables several very interesting conclusions showing the total unreasonableness of trying to reason about model based CIs without scientizing this reasoning. Namely, that
   For implementing an IES^{FFOLLN} (as claimed by a claim 16-30)—the 35 USC SPL is just a specific FFOLLN—neither a concrete FFOLLN nor the FSTP^{FFOLLN}-Test is needed (i.e. it is sufficient to know that it is FFOL) nor a CI^{FFOLLN}. By calibrating a so implemented “abstract” IES^{FFOLLN} by a CI^{FFOLLIN}'s PTR^{FFOLLIN}-DS (based on a concrete FFOLLN, concrete CI^{FFOLLIN}, and concrete FSTP^{FFOLLIN}-Test here needed for construing the PTR^{FFOLLIN}-DS) it becomes an IES^{FFOLLIN} all-knowing about CI^{FFOLLIN}'s satisfying FFOLLN.
   for none of the application areas of the CI disclosed by this patent application (one of them being the “35 USC SPL area”)—all being “FFOLLN areas”—the FSTP^{FFOLLN}-Test can be defined without basing it on a FFOL CI. I.e., any FFOL CI from a FFOLLN area creates, by its FSTP^{FFOLLIN}-Test, its specific compound metric for any prior just as posteriori art over the posc underlying this FFOLLN area.
   recognizing any CI creates its own metric was not really necessary with classical technology CIs—there intuition insinuates it always is the same (though not understood by anybody prior to FSTP technology)—for model-based emerging technology CIs no intuition exists, thus making indispensable the scientification of their tests for satisfying their FFOLLNs, whatsoever [79].
The below quoted and underlined phrases used by the specification have the following meanings:
   a) “on direct or indirect request by an IES user” says that this IES user may by itself invoke a function (=request its execution directly) or else it may be prompted by the IES to invoke a function (=request its execution indirectly).
   b) “several different LACs about any AST of a CI/TT.0” shall indicate that the existence of several LACs need not only be due to an IES user having defined several different multimedia presentations for a LAC, but may also be caused by the AST itself comprising different ways of reasoning, e.g. having different disclosures for an inC the AST deals with and/or having for a disclosure more than one legal justification.
   c) An answer provided by the IES to a query put by an IES user (as to at least one aspect of at least one inC of the CI at issue) is called “complete and concise” if it addresses and comprises all relevant legal and technical information and presents this information such that it shows the CI meets all respective requirements stated by SPL—unlike information provided by the classical claim construction, as missing both these objectives.
   d) “question raised by an IES user intentionally or not” says that the user may raise this question quite purposefully, i.e. targeted, or incidentally, i.e. by chance e.g. in presenting an argument.
   e) The different “logics” of an AST denote the various kinds this AST may present some issue, e.g. justify why an inC is disclosed by the specification or why the inCs in a set are independent.
   f) “All ASTs for a given CI and its FFOLLIN” says that any part of this CI's FSTP^{FFOLLIN}-Test is covered by an AST, i.e. the CI's complete FSTP^{FFOLLIN}-Test understood as a logical conjunction of basic logic statements is decomposed into sets of BASTs (see γ) above).
   g) Two LACs are “nonredundant”, if the ASTs they represent share no BAST.

### III. THE MEANINGS OF THE CI'S inCs AND OF SOME CLAIMS' WORDINGS

The independent claim(ed invention), CI—w.l.o.g. the plural is ignored for simplicity—is made-up from instantiations of 5 (BED-) inCs, namely: “KR-UIE”, “HI-UIE”, “IC-UIE”, “AST”, and “LAC”. Their meanings are principally explained in Section I, exemplified throughout the specification of this patent application, and here described by their usefulness in glossary like style.

The 5 inCs are references to information (sometimes dealt with as if they contained them), which the IES (semi-)automatically generates and uses, as defined in much detail in this specification. The claims, hence, contribute to disclosing/describing this CI's inventive concepts, in particular their respective incremental contributions to the usefulness of this CI. Some of the dependent CIs are based on further disclosed inCs, not elaborated on, here.

The incremental usefulness [18,19] of the 5 inCs and all their 35 USC SPL implications needs to be instantly proven in realtime-mode only, their additional and potentially more elaborately presented usefulness considerations in config-mode is taken as granted. The incremental usefulness of these 5 inCs (in realtime-mode) is here defined—as their manifestation by means of an IES comprising its at least one instantiation or capable of creating it as well as invoking it instantly, not by means of the method controlling it and enabling the same definition, but being totally intangible/invisible—for the
LAC as follows: Any instantiation of it—when invoked (and created by the IES for its partial existence during the execution of the UIE.Y defining it) on direct or indirect request by an IES user—responds to one of the finitely many questions (anticipated in its config-mode) by an answer potentially in multimedia presentation (determined in its config-mode) instantly, correctly, completely, concisely, and to some degree user controllable by an IES user as to this answer's presentation and/or its logics. The occurrence of this question, raised by an IES user intentionally or not, is the reason of this instantiation's invocation. The issue addressed by this question is one of the finitely many aspects of testing a given CI for its satisfying the requirement(s) stated by the given respective FFOLLIN instantiation. The set of all LACs defined, for a given FFOLLIN and its CI in config-mode, establishes the total usefulness of this CI provided by the so configured IES in this FFOLLIN.
AST as follows: Any instantiation of it enables accessing a specific part of the FSTP-DS—potentially finer than that of an FSTP-test.o and/or stretching over parts of several FSTP-test.o—whereby all ASTs, for a given CI and its FFOLLIN, in total cover this CI's FSTP^{FFOLLIN}-DS. Thus, the usefulness of an AST instantiation consists in its providing access, in the CI's test for satisfying its given FFOLLIN, to that part of the FSTP^{FFOLLIN}-Test represented by this AST instantiation.
IC-UIE as follows: Any instantiation of it enables structuring and controlling the presentation of any part of any LAC.
HI-UIE as follows: Any instantiation of it enables determining the multimedia aspects and didactic presentation of any LAC.
KR-UIE as follows: Any instantiation of it enables supporting the presentation of any LAC by an appropriate choice of the logics of the AST.

(Non-) Functional meanings of the claims' wordings, for which posc recognizes how they fit into this CI—posc is that of an experienced IT system designer additionally familiar with SPL and the Supreme Court's KSR/Bilski/Mayo/Myriad decisions as discussed in [71,78]—remain without explanations. Those as to the 15 method claims apply the same way also to the subsequent system claims.

Finally, a few definitions/explanations/comments as to the claims are needed/useful:
claim 1: Bold italic acronyms denote sets. In the definition of a LAC the term “prove” should perhaps be replaced by the term “reasons” or “argues”. W.l.o.g., this explanation may assume that the given PTR-DS comprises only a single TT.0.
   The term “automatically identifies” means that the IES, when intending to invoke another user interaction, always first checks whether a user request is pending. If so, it serves this request, otherwise it checks whether it may prompt the user to request a user interaction, and if so, it issues this prompt.
claim 7: From the parent patent application follows that it is known how to complete a partial PTR-DS. By footnote 2 this also applies for any FFOLLN resp. FFOLLIN.
claim 9: For being able to perform this check this CI would restrict the power of the notation accordingly.

### IV. THIS PATENT APPLICATION'S CI SATISFIES THE 35 USC'S SPL

By [11,25], the here claimed invention satisfies the 35 USC §§101/102/103/112 as it passes all 10 FSTP tests.o outlined by FIG. 3. It namely passes³⁾ ³ Performing the NANO test on this CI determines its creative height to be ≧5 over posc, and there is no prior art or pragmatics which could reduce it. By [5,6], this CI's creative height is
larger than 1, thus warranting its novelty (as by the posc there is no prior art document anticipating one of the 5 above BID-inCs), and as it is especially at least
5 or more, thus warranting its nonobviousness, due to the same reason.
FSTP test 1: Technically, all claimed inventions—as of claims 1 and 16 and of their dependent claims—are made-up by at least the 5 or more BED-crCs quoted at the beginning of Section III, each contributing to increasing an IES's usefulness in generating/customizing/invoking LACs. Disaggregating them is obsolete, i.e. performing the FSTP test 1 is trivial.
FSTP test 2: These 5 BED-crCs are lawfully disclosed by Sections I-IV, i.e. are 5 BED-inCs. And: The FSTP-Test of the sole invention claimed by a claim uses the single set of these 5 inCs.
FSTP test 3: None of the claims comprises a “means-plus-function” wording.
FSTP test 4: The disclosures in Sections I-IV of the 5 BED-crCs and hence of this CI are enabling.
FSTP test 5: The 5 BED-inCs are evidently independent.
FSTP test 6: The 5 BED-inCs are posc-nonequivalent, as there is no prior art and no posc for them.
FSTP test 7: The claimed invention passes the NAIO test, as its total usefulness is outlined in Section I and in Sections II-IV described precisely by its 5 inCs (as identified at the beginning of Section III), and if one of these 5 inCs is left away it does no longer have the specified usefulness. Hence, none of the claimed inventions is an abstract idea only.
FSTP test 8: The claimed invention is evidently not a natural phenomenon solely; the contrary is true: none of its 5 inCs represents a natural phenomenon.
FSTP test 9: The claimed invention is evidently novel and nonobvious⁴⁾.
FSTP test 10: The claimed invention is not idempotent, because none of its 5 inCs is trivial.

Hence, as stated above, the here claimed invention satisfies 35 USC's SPL.

Finally, it is worthwhile noticing that this CI passes, by passing all 10 FSTP tests, even 16 tests, as shown by FIG. 4—of which the classical claim construction only performs 6 ones, as explained by [25]. To put this insight into the Mayo context: If the classical claim construction were allegedly seen as an invention being that useful as to determine whether a claimed invention satisfies the US SPL or not, it would be—as seen by Bilski/Mayo—just an “abstract idea only” of a claim construction. Though, strangely enough, the classical claim construction never has been set out to be that useful. Indeed, it is more misleading than guiding to the complete and 35 USC conforming and by Mayo required claim construction?.

### BRIEF DESCRIPTION OF THE DRAWINGS

FIG. 1 shows an AST.1 translated into 3 LAC.a/b/c by their UIE.1a/1b/1c of 1/2/3 sequential UIE.1a^{[1]}/1b^{[1,2]}/1c^{[1,2,3]} steps semi-automatically generated/customized in config-mode by defining by an IES user their respective 6 <HI-UIE.Ys, KR-UIE.Ys, IC-UIE.Ys>.

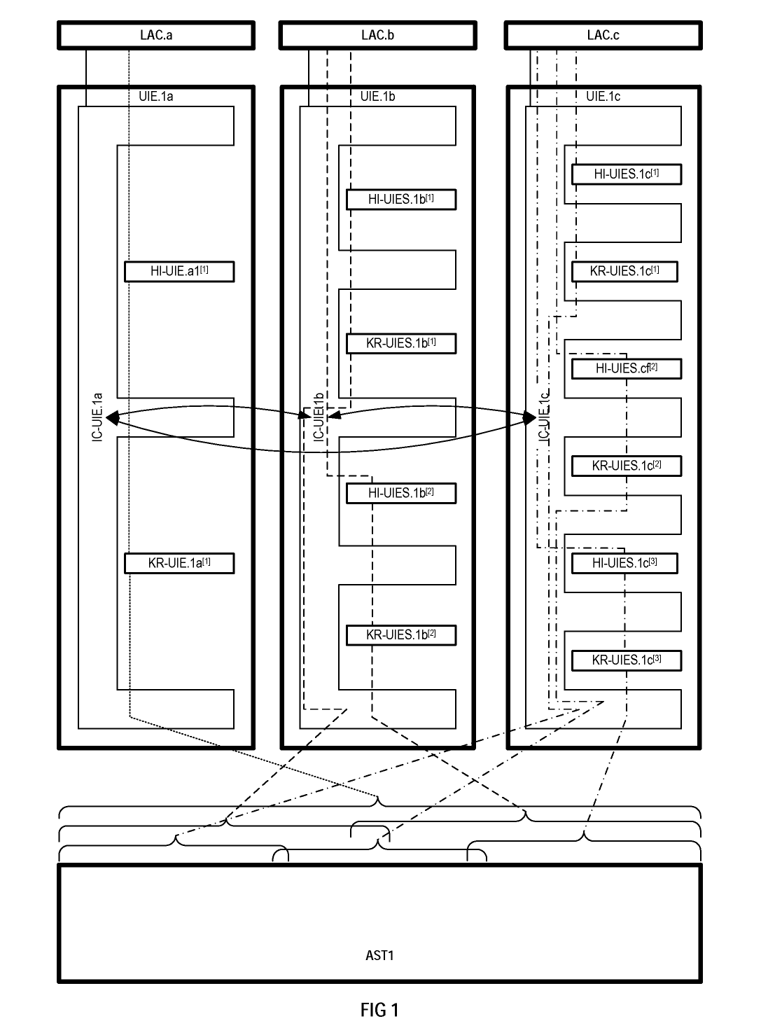

FIG. 2 shows that AST.1 may have 2 logics presentations, leading to 3 more powerful LAC.d/e/f by their UIE.1d/1e/1f, again based on 6 steps (lines) in total.

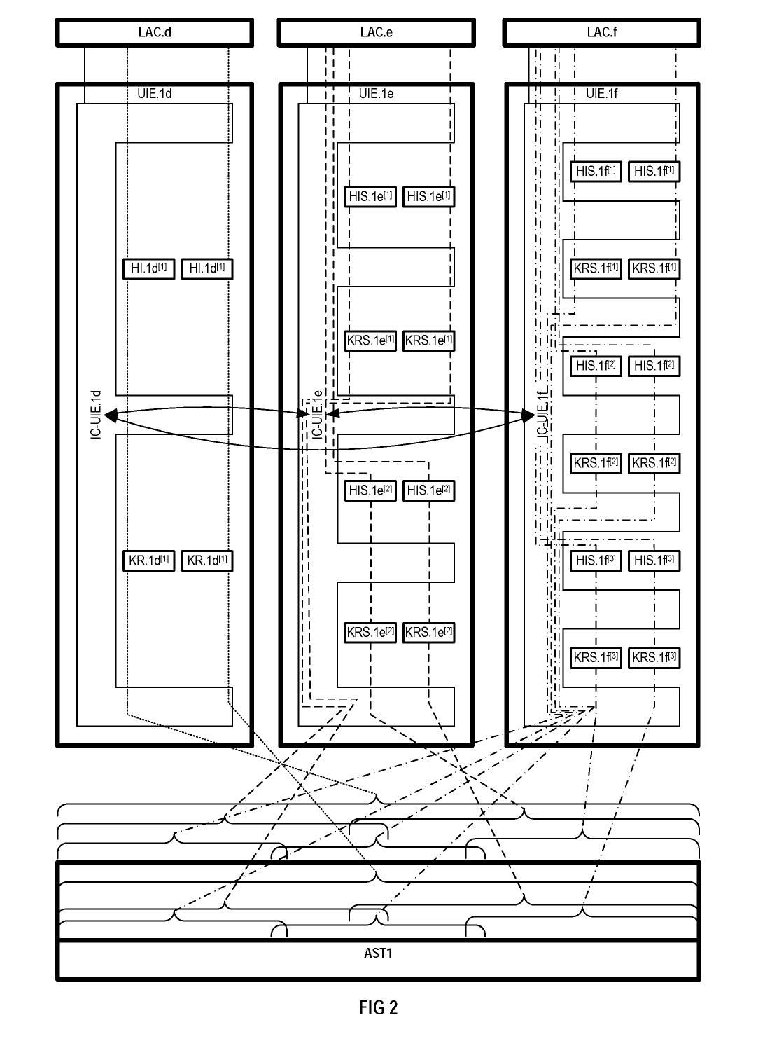

FIG. 3 shows the FSTP-Test, consisting of the 10 FSTP-test.o.

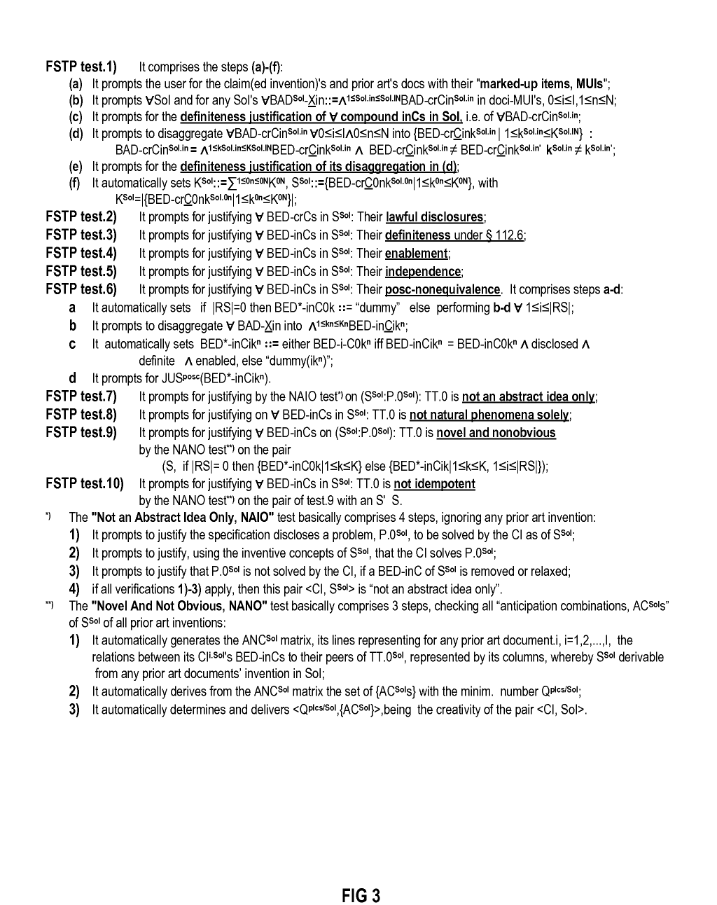

FIG. 4 shows the compound USC SPL expressed by the elementary FSTP tests.

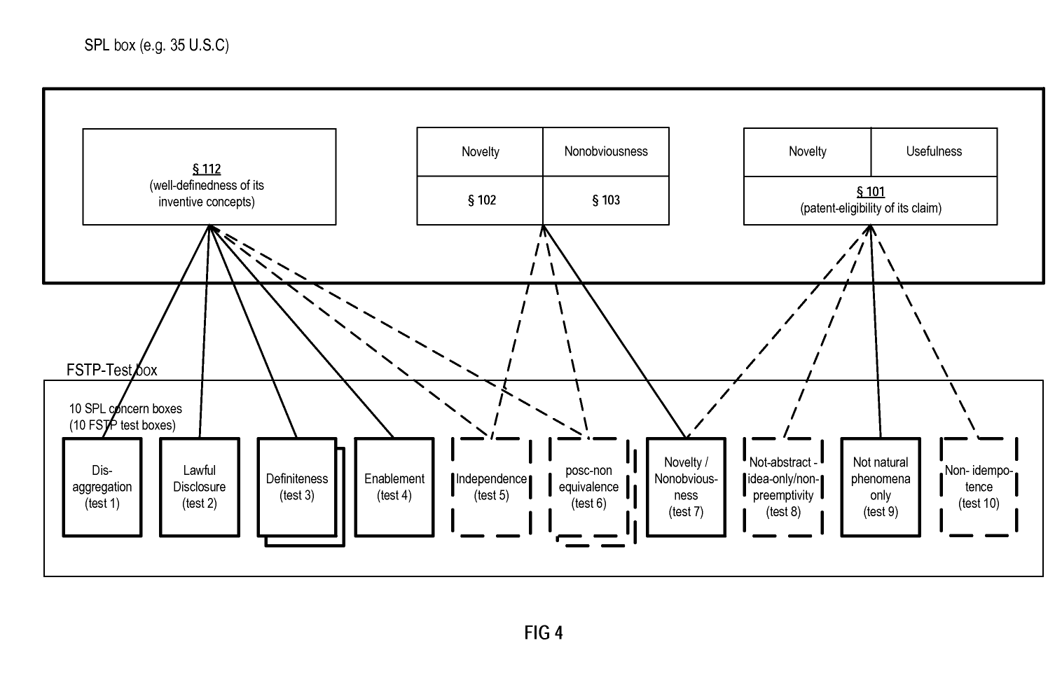

### ANNEX TO THE SPECIFICATION

### Reference List (V.7)

[1] S. Schindler: “US Highest Courts' Patent Precedents in Mayo/Myriad/CLS/Ultramercial/LBC: ‘Inventive Concepts’ Accepted—‘Abstract Ideas’ Next? Patenting Emerging Tech. Inventions Now without Intricacies” *).
[2] “Advanced IT” denotes IT research areas, e.g. Al, Semantics, KR, DL, NL, . . . .
[3] R. Brachmann, H. Levesque “Knowledge Representation & Reasoning”, Elsevier, 2004.
[4] “The Description Logic Handbook”, Cambridge UP, 2010.
[5] S. Schindler: “Math. Model. Substantive Patent Law (SPL) Top-Down vs. Bottom-Up”, Yokohama, JURISIN 2013*).
[6] SSBG pat. appl.: “THE FSTP EXPERT SYSTEM”*).
[7] SSBG pat. appl.: “AN INNOVATION EXPERT SYS., IES, & ITS DATA STRUC., PTR-DS”*).
[8] J. Schulze: “TECHNICAL REPORT #1.V1 ON THE '882 PTR AND THE UI OF THE IES PROTOTYPE”, in prep.
[9] S. Schindler: “Patent Business—Before Shake-up”, 2013*)
[10] SSBG's AB to CAFC in LBC, 2013*).
[11] SSBG pat. appl.: “INV. CONC. ENABL. SEMI-AUTOM. PATENT TESTS”*).
[12] C. Correa: “Res. Handbook on Protection of IP under WTO Rules”, EE, 2010.
[13] N. Klunker: “Harmonisierungsbestr. im mat. Patentrecht”, MPI, Munich, 2010.
[14] USPTO/MPEP: “2111 Claim Interpretation; Broadest Reason. Interpr. [Eighth Ed., Rev. 1],”*) USPTO/MPEP: “2111 Claim Interpretation; Broadest Reason. Interpr. [Eighth Ed., Rev. 2],”*) USPTO/MPEP: “2111 Claim Interpretation; Broadest Reason. Interpr. [Eighth Ed., Rev. 3],”*) USPTO/MPEP: “2111 Claim Interpretation; Broadest Reason. Interpr. [Eighth Ed., Rev. 4],”*) USPTO/MPEP: “2111 Claim Interpretation; Broadest Reason. Interpr. [Eighth Ed., Rev. 5],”*) USPTO/MPEP: “2111 Claim Interpretation; Broadest Reason. Interpr. [Eighth Ed., Rev. 6],”*) USPTO/MPEP: “2111 Claim Interpretation; Broadest Reason. Interpr. [Eighth Ed., Rev. 7],”*) USPTO/MPEP: “2111 Claim Interpretation; Broadest Reason. Interpr. [Eighth Ed., Rev. 8],”*) USPTO/MPEP: “2111 Claim Interpretation; Broadest Reason. Interpr. [Eighth Ed., Rev. 9],”*).
[15] S. Schindler: “KR Support for SPL Precedents”, Barcelona, eKNOW-2014*).
[16] J. Daily, S. Kieff: “Anything under the Sun Made by Humans SPL Doctrine as Endogenous Institutions for Commercial Innovation”, Stanford and GWU*).
[17] CAFC En ban Hearing in LBC, 12.9.13.
[18] SSBG AB to the Supreme Court in CLS, 07.10.2013*).
[19] SSBG AB to the Supreme Court in WildTangent, 23.09.2013*).
[20] USPTO, “Intell. Prop. and the US Economy: INDUSTR. IN FOCUS”, 2012*).
[21] K. O'Malley: Keynote Address, IPO, 2013*).
[22] S. Schindler, “The View of an Inventor at the Grace Period”, Kiev, 2013*).
[23] S. Schindler, “The IES and its In-C Enabled SPL Tests”, Munich, 2013*).
[24] S. Schindler, “Two Fundamental Theorems of “Math. Innovation Science”, Hong Kong, ECM-2013*).
[25] S. Schindler, A. Paschke, S. Ramakrishna, “Form. Legal Reason. that an Invention Sat. SPL”, Bologna, JURIX-2013*).
[26] SSBG AB to the Supreme Court in Bilski, 6.8.2009*).
[27] T. Bench-Capon, F. Coenen: “Isomorphism. and Legal Knowl. Based Systems”, Al&Law, 1992*).
[28] N. Fuchs, R. Schwitter. “Attempt to Controlled English”, 1996.
[29] A. Paschke: “Rules and Logic Programming in the Web”. 7. ISS, Galway, 2011.
[30] K. Ashley, V. Walker, “From Information Retrieval to Arg. Retrieval for Legal Cases: . . . ”, Bologna, JURIX-2013*).
[31] Hearing in Oracle vs. Google, “As to Copyrightability of the Java Platform”, CAFC, 6.12.2013.
[32] S. Schindler, “A KR Based Innovation Expert System (IES) for US SPL Precedents”, Phuket, ICIM-2014*).
[33] S. Schindler, “Status Report about the FSTP Prototype”, Hyderabad, GIPC-2014.
[34] S. Schindler, “Status Report about the FSTP Prototype”, Moscow, LESI, 2014.
[35] S. Schindler, “Substantive Trademark Law STL), Substantive Copyright Law (SCL), and SPL STL Tests Are True SCL Subtests, and SCL Tests Are True SPL Subtests”, in prep.
[36] S. Schindler, “Boon and Bane of Inventive Concepts and Refined Claim Construction in the Supreme Court's New Patent Precedents”, Hawaii, IAM-2014*).
[37] D.-M. Bey, C. Cotropia, “The Unreasonableness of the BRI Standard”, AIPLA, 2009*)
[38] Transcript of the Hearing in TELES vs. CISCO/USPTO, CAFC, 8.1.2014*).
[39] Transcript of the en banc Hearing in CLS vs. ALICE, CAFC, 8.2.2013*).
[40] SSBG's Brief to the CAFC in case '453*).
[41] SSBG's Brief to the CAFC in case '902*).
[42] SSBG's Amicus Brief to the CAFC in case CLS, 06.12.2012*).
[43] SSBG pat. appl. “An IES Capable of Semi-Autom. Generating/Invoking All Legal Argument Chains (LACs) in the SPL Test of a Claimed Invention (CI), as Enabled by Its Inventive Concepts (inCs)”,*).
[44] R. Rader, Panel Discussion “Patent on Life Sciences”, Berlin, 28.11.2012.
[45] SSBG's AB to the Supreme Court as to the CII Question, Jan. 28, 2014*).
[46] S. Schindler: “Autom. Deriv. of Leg. Arg. Chains (LACs) from Arguable Subtests (ASTs) of a Claimed Invention's Test for Satisfying. SPL”, University of Warsaw, 24.05.20141.
[47] S. Schindler: “Auto. Gen. of All ASTs for an Inv.'s SPL Test”, subm. for public,
[48] USPTO/MPEP, “2012 . . . Proc. for Subj. Matter Eligibility . . . of Process Claims Involving Laws of Nature”, 2012*).
[49] USPTO/MPEP, Guidelines 35 U.S.C. 112(2), Federal Register/Vol. 76, No. 27; MPEP 2171, Rev. 9, August 2012*).
[50] NAUTILUS v. BIOSIG, PFC, 2013*).
[51] BIOSIG, Respondent, 2013*)
[52] Public Knowledge et al., AB, 2014*).
[53] Amazon et al., AB, 2014*).
[54] White House, FACT SHEET— . . . the President's Call to Strength. Our Patent System and Foster Innovation, 2014*).
[55] USPTO: see home page.
[56] IPO: see home page.
[57] M. Adelman, R. Rader, J. Thomas: “Cases and Materials on Patent Law”, West AP, 2009.
[58] SSBG's Amicus Brief to the Supreme Court as to its (In)Definiteness Questions, Mar. 3, 2014*).
[59] SSBG pat. appl. “A Patent Interpretations and inCs Minded UI of an IES”.
[60] S. Schindler: “A Patent Interpretation(s) and an inCs Minded UI of an IES”, in preparation, 2014.
[61] H. Wegner: “Indefiniteness, the Sleeping Giant in Patent Law”, www.laipla.net/hal-wegners-top-ten-patent-cases/.
[62] CAFC opinion in Case No. 12-1513, reexamination no. 95,001,001 of U.S. Pat. No. 7,145,902, Feb. 21, 2014*).
   CAFC opinion in Case No. 12-1297, reexamination no. 90/010,017 of U.S. Pat. No. 6,954,453 Apr. 4, 2014*).
[63] B. Wegner, S. Schindler: “A Mathematical Structure for Modeling Inventions”, Coimbra, CICM-2014*).
[64] SSBG's Petition to the CAFC for Rehearing En Banc in the '902 case, 18.04.2014*).
[65] CAFC: VEDERI vs. GOOGLE decision; Mar. 14, 2014
[66] CAFC: THERASENSE vs. BECTON & BAYER decision, 25.05.2011
[67] B. Fiacco: Amicus Brief to the CAFC in VERSATA v. SAP&USPTO, 24.03.14*).
[68] Official Transcript of the oral argument in U.S. Supreme Court, Alice Corp. v CLS Bank, Case 13-298—Subject to final Review, Mar. 31, 2014, Alderson Reporting Company*).
[69] R. Rader, Keynote Speech: “Patent Law and Litigation Abuse”, ED Tex Bench and Bar Conf., Nov. 1, 2013*).
[70] S. Schindler, Keynote Speech: “eKnowledge About Substantive Patent Law (SPL)—Trail Blazer into the Innovation Age”, Barcelona, eKNOW-2014*).
[71] S. Schindler: “The Supreme Court's ‘SPL Initiative’: Scientizing Its SPL Interpretation Clarifies Three Initially Evergreen SPL Obscurities”, submitted for publ., 2014*).
[72] USPTO/MPEP: “2014 Procedure For Subject Matter Eligibility Analysis Of Claims Reciting Or Involving Laws Of Nature/Natural Principles, Natural Phenomena, And/Or Natural Products” *).
[73] B. Wegner, S. Schindler: “The Mathematical Structure for Modeling the Refined Claim Construction”, in prep.
[74] T.b.d.
[75] D. Crouch: “En Banc Federal Circuit Panel Changes the Law of Claim Construction”, 13.07.2005.
[76] Video of the Hearing on 9 May 2014 organized by the PTO*).
[77] R. Rader, Keynote Speeches at GTIF, Geneva, 2014 and LESI, Moscow, 2014
[78] S. Schindler: “On the BRI-Schism in the US National Patent System (NPS), A Challenge for the US Highest Courts”, May 22, 2014, subm. for publ.*)
[79] SSBG's Petition for Writ of Certiorari to the Supreme Court in the '902 case, in preparation.

*) see www.fstp-expert-system.com

What is claimed is:

1. A computer-implemented method, by its execution
realizing an “Innovation Expert System, IES”—comprising at least a processor, a memory for storing the method's executable code for the processor, at least one I/O device for IES's interactions with an IES user, an “Items/Events Memory, I/EM” for storing all items and events the method refers to, and a “User Interface Entity, UIE” ::={<KR-UIE, HI-UIE, IC-UIE>.Y|YεY^{UIE}}—
in its config-mode generating and customizing a set of “legal argument chain, LAC”, {LAC},
for a given “PTR Data Structure, PTR^{FFOLLIN}-DS” determined by the FSTP^{FFOLLIN}-Test,
and an “Arguable Subtest, AST”εFSTP^{FFOLLIN}-Test—omitting “^{FFOLLIN}” in the future—with {LAC}::={LAC^{AST}.Z|LAC^{AST}.Z proves TT.0 passes AST∀ZεZ^{AST}}, whereby ∀ZεZ^{AST}⊂Y^{UIE} holds
KR-UIE.Z comprises the AST,
HI-UIE.Z is input by a user, and
IC-UIE.Z is determined by a user;
in its realtime-mode presenting an invoked generated and/or customized LAC^{AST}.Z, ZεZ^{AST};
when executed by the IES, the latter repeatedly consecutively invokes and completely executes, for any IES user separately, the action A) when the IES is in a config-mode resp. the action B) when the IES is in a realtime-mode, which means that for an IES user the IES then
A) i. automatically identifies a ZεZ^{AST} for which a LAC^{AST} exists already or an ASTεFSTP-Test(PTR) to be transformed into a LAC,
ii. automatically prompts a user to input into said identified KR-UIE.Z said AST, into its HI-UIE.Z what the representation shall be of this AST on what I/O device, and into its IC-UIE.Z what interactive control a user shall have during said representation of said AST,
iii. automatically may accept information from at least one IES user to be communicated to at least one other IES user's I/O device(s),
iv. on request of an IES user toggles this IES user's mode of the IES to the realtime-mode.
B) i. automatically identifies a LACε{LAC^{AST}},
ii. automatically identifies an AST then automatically identifies a LACε{LAC^{AST}},
iii. on having determined said LAC, presents it as defined in A)ii. or predefined,
iv. automatically may accept information from at least one IES user to be communicated to at least one other IES user's I/O device(s);
v. on request of an IES user toggles this IES user's mode of the IES to the config-mode.

2. A computer-implemented method according to claim 1), whereby the representation of a user input that the IES requires may be identified by a user, either by selecting said representation from an IES given set of such representations or by describing it in an IES given notation.

3. A computer-implemented method according to claim 1), whereby the representation of an IES output for use by at least one IES user may be identified by a user, either by selecting said representation from an IES given set of such representations or by describing it in an IES given notation.

4. A computer-implemented method according to claim 1), whereby a user input triggers an IES function that automatically or interactively with a user generates or modifies at least a part of a KR-UIE.Y or HI-UIE.Y or IC-UIE.Y.

5. A computer-implemented method according to claim 1), whereby the IES provides to a user, for a UIE.Y, the capability of subdividing it or a step of it into steps and to remove such a subdivision, whereby performing a subdivision or removing it may be determined by the IES controlled by a user or by an IES user and any operation defined in A) and B) may be applied to a step.

6. A computer-implemented method according to claim 1), whereby at least one AST may be completely input by an IES user, or derived by the IES from at least one PTR-DS part identified by an IES user interactively with an IES user, or automatically.

7. A computer-implemented method according to claim 1), whereby the PTR-DS may be partially input or modified or verified by an IES user and—if incomplete—completed by the IES interactively with an IES user.

8. A computer-implemented method according to claim 1), whereby the FFOLLIN may be provided by the PTR-DS, or input by an IES user either by selecting a FFOLLN from an IES given set of such FFOLLNs and complete the selected FFOLLN to a FFOLLIN by inCs of the TT.0 of the given PTR, alternatively by describing it or a FFOLLN in an IES given notation.

9. A computer-implemented method according to claim 1), whereby an IES user may limit its SPL by a document, the additional limitations of which on the TT.0 under test are described in some notation provided by the IES, whereby the IES checks that the FFOL property of the resulting set of limitations is preserved.

10. A computer-implemented method according to claim 1), whereby an IES user may—by IES given procedures—mark-up at least one part of the PTR-DS and of the UIE used by the TT.0 test at issue and sign it in an authenticable way, just as identify any such part and authenticate it, just as to have the IES monitor its use by such IES procedures, write a log file as to its use, and inform an IES user about its use instantly or if an IES user configurable IES given event occurs.

11. A computer-implemented method according to claim 1), whereby an IES user may identify the actual state of the IES, toggle between different such identified states, and thereby get from the IES the description of differences between both states, presented as configured by an IES user in a notation provided by the IES.

12. A computer-implemented method according to claim 1), whereby an IES user may undo its most recent interaction with the IES, which changed its I/EM.

13. A computer-implemented method according to claim 1), whereby an IES user may enable/disable at least one other IES user to/from at least one interaction with an IES user.

14. A computer-implemented method according to claim 1), whereby an IES user may synchronize a part—selectable by an IES user from a set of parts provided by the IES or described by an IES user in a notation provided by the IES—of the presentation of the IES to at least two IES users.

15. A computer-implemented method according to claim 1), whereby an IES user may request a part—selectable by an IES user from a set of parts provided by the IES or described by an IES user in a notation provided by the IES—of the log-file of a period of the IES execution for a TT.0 test.

16. A computer-implemented system, by its execution
realizing an “Innovation Expert System, IES”—comprising at least a processor, a memory for storing the method's executable code for the processor, at least one I/O device for IES's interactions with an IES user, an “Items/Events Memory, I/EM” for storing all items and events the method refers to, and a “User Interface Entity, UIE” ::={<KR-UIE, HI-UIE, IC-UIE>.Y|YεY^{UIE}}—
in its config-mode generating and customizing a set of “legal argument chain, LAC”, {LAC},
for a given “PTR Data Structure, PTR^{FFOLLIN}-DS” determined by the FSTP^{FFOLLIN}-Test,
and an “Arguable Subtest, AST”εFSTP^{FFOLLIN}-Test—omitting “^{FFOLLIN}” in the future—with {LAC}::={LAC^{AST}.Z|LAC^{AST}.Z proves TT.0 passes AST∀ZεZ^{AST}}, whereby ∀ZεZ^{AST}⊂Y^{UIE} holds
KR-UIE.Z comprises the AST,
HI-UIE.Z is input by a user, and
IC-UIE.Z is determined by a user;
in its realtime-mode presenting an invoked generated and/or customized LAC^{AST}.Z, ZεZ^{AST};
when executed by the IES, the latter repeatedly consecutively invokes and completely executes, for any IES user separately, the action A) when the IES is in a config-mode resp. the action B) when the IES is in a realtime-mode, which means that for an IES user the IES then
A) i. automatically identifies a ZεZ^{AST} for which a LAC^{AST} exists already or an AST E FSTP-Test(PTR) to be transformed into a LAC,
ii. automatically prompts a user to input into said identified KR-UIE.Z said AST, into its HI-UIE.Z what the representation shall be of this AST on what I/O device, and into its IC-UIE.Z what interactive control a user shall have during said representation of said AST,
iii. automatically may accept information from at least one IES user to be communicated to at least one other IES user's I/O device(s),
iv. on request of an IES user toggles this IES user's mode of the IES to the realtime-mode.
B) i. automatically identifies a LACε{LAC^{AST}},
ii. automatically identifies an AST then automatically identifies a LACε{LAC^{AST}},
iii. on having determined said LAC, presents it as defined in A)ii. or predefined,
iv. automatically may accept information from at least one IES user to be communicated to at least one other IES user's I/O device(s);
v. on request of an IES user toggles this IES user's mode of the IES to the config-mode.

17. A computer-implemented system according to claim 16), whereby the representation of a user input that the IES requires may be identified by a user, either by selecting said representation from an IES given set of such representations or by describing it in an IES given notation.

18. A computer-implemented system according to claim 16), whereby the representation of an IES output for use by at least one IES user may be identified by a user, either by selecting said representation from an IES given set of such representations or by describing it in an IES given notation.

19. A computer-implemented system according to claim 16), whereby a user input triggers an IES function that automatically or interactively with a user generates or modifies at least a part of a KR-UIE.Y or HI-UIE.Y or IC-UIE.Y.

20. A computer-implemented system according to claim 16), whereby the IES provides to a user, for a UIE.Y, the capability of subdividing it or a step of it into steps and to remove such a subdivision, whereby performing a subdivision or removing it may be determined by the IES controlled by a user or by an IES user and any operation defined in A) and B) may be applied to a step.

21. A computer-implemented system according to claim 16), whereby at least one AST may be completely input by an IES user, or derived by the IES from at least one PTR-DS part identified by an IES user interactively with an IES user, or automatically.

22. A computer-implemented system according to claim 16), whereby the PTR-DS may be partially input or modified or verified by an IES user and—if incomplete—completed by the IES interactively with an IES user.

23. A computer-implemented system according to claim 16), whereby the FFOLLIN may be provided by the PTR-DS, or input by an IES user either by selecting a FFOLLN from an IES given set of such FFOLLNs and complete the selected FFOLLN to a FFOLLIN by inCs of the TT.0 of the given PTR, alternatively by describing it or a FFOLLN in an IES given notation.

24. A computer-implemented system according to claim 16), whereby an IES user may limit its SPL by a document, the additional limitations of which on the TT.0 under test are described in some notation provided by the IES, whereby the IES checks that the FFOL property of the resulting set of limitations is preserved.

25. A computer-implemented system according to claim 16), whereby an IES user may—by IES given procedures—mark-up at least one part of the PTR-DS and of the UIE used by the TT.0 test at issue and sign it in an authenticable way, just as identify any such part and authenticate it, just as to have the IES monitor its use by such IES procedures, write a log file as to its use, and inform an IES user about its use instantly or if an IES user configurable IES given event occurs.

26. A computer-implemented system according to claim 16), whereby an IES user may identify the actual state of the IES, toggle between different such identified states, and thereby get from the IES the description of differences between both states, presented as configured by an IES user in a notation provided by the IES.

27. A computer-implemented system according to claim 16), whereby an IES user may undo its most recent interaction with the IES, which changed its I/EM.

28. A computer-implemented system according to claim 16), whereby an IES user may enable/disable at least one other IES user to/from at least one interaction with an IES user.

29. A computer-implemented system according to claim 16), whereby an IES user may synchronize a part—selectable by an IES user from a set of parts provided by the IES or described by an IES user in a notation provided by the IES—of the presentation of the IES to at least two IES users.

30. A computer-implemented system according to claim 16), whereby an IES user may request a part—selectable by an IES user from a set of parts provided by the IES or described by an IES user in a notation provided by the IES—of the log-file of a period of the IES execution for a TT.0 test.
